(19) United States
(12) Patent Application Publication
(10) Pub. No.: US 2024/0263673 A1
(43) Pub. Date: Aug. 8, 2024

(54) A METHOD FOR MANUFACTURING A SENSORIZED BEARING RING

(71) Applicant: AKTIEBOLAGET SKF, GOTEBORG (SE)

(72) Inventors: Marcus C. ANDERSSON, Molndal (SE); Esteban Daniel BROITMAN, Houten (NL); Marcel ESCURSELL, Goteborg (SE)

(21) Appl. No.: 18/559,828

(22) PCT Filed: May 30, 2022
(86) PCT No.: PCT/EP2022/064631

§ 371 Date: Nov. 9, 2023

(30) Foreign Application Priority Data
Jun. 2, 2021 (DE) 102021205650.4

(51) Int. Cl. F16C 41/00; F16C 33/58; F16C 43/04

(52) U.S. Cl. CPC F16C 41/00; F16C 33/585; F16C 43/04; F16C 2233/00

(57) ABSTRACT

A method for manufacturing a sensorized bearing ring includes the steps of: providing a metallic ring member, applying a sensor member on the metallic ring member, and applying a raceway layer onto the metallic ring member and the sensor member by use of a metallic wire Directed Energy Deposition (DED) operation and/or a metallic powder DED operation.

### TECHNICAL FIELD

The present invention concerns a method for manufacturing a sensorized bearing ring. The present invention also concerns a sensorized bearing ring and a sensorized bearing.

### BACKGROUND OF THE INVENTION

Rolling bearings are well-known mechanical components in rotating machinery, used for carrying loads while allowing a relative rotation between their bearing rings via rolling elements, such as balls and rollers, that rolls onto raceways of the rings.

Rolling bearings are often a key critical wear component of a machine, therefore highly interesting to equip with sensors to measure its condition in order to prevent failures and plan maintenance. Further, sensorized bearings can often provide much information about the condition of the machinery itself, providing valuable data to operators about loads, temperature, rotating speed, to give a few examples. As the possibilities to transmit data is ever increasing, so are the opportunities to measure more points in a machinery, for instance to provide a more refined servicing of the same based on actual needs. Preferably, the sensors should be placed close to the raceway of the ring onto which the rolling elements roll over to get an accurate signal. Preferably the sensors should be places underneath the rolling elements, so that the sensors are over rolled by the rolling elements. This yields an accurate reading of the actual load and temperature at the region where it matters the most, i.e. where the load, friction and its generated temperature usually are at its highest in the bearing.

Existing solution to make sensing bearings with sensors that can be over rolled are either expensive or not reliable. Sensors can be applied onto the raceway in different ways, but it will be worn out quickly by the rolling elements. Bearings can also be equipped with optical fibers underneath the raceway. This is technically good from sensing and reliability perspective, but very expensive and difficult to manufacture, since the tracks for the optic fiber need to be hard milled on the bearing rings after grinding. Thus, this solution is only used for special applications or for testing purposes.

Thus, there is a need to provide reliable sensorized bearings in a cost-efficient manner.

### SUMMARY OF THE INVENTION

In view of the above, an object of the invention is to provide an improved method for manufacturing a sensorized bearing ring which to at least some extent overcomes some of the issues with the prior art. A further object is to provide an improved sensorized bearing ring. A yet further object is to provide an improved sensorized bearing.

At least one of these objects is achieved by the steps recited in claim 1. Thus, a method for manufacturing a sensorized bearing ring is provided. The method comprises the steps of:
providing a metallic ring member,
applying a sensor member on the metallic ring member
applying a raceway layer onto the metallic ring member and the sensor member by use of a metallic wire Directed Energy Deposition (DED) operation and/or a metallic powder DED operation.

By the provision of the method as disclosed herein, an improved sensorized bearing ring is provided, in which the sensor member has at least one raceway layer applied to it by a DED operation, such as a laser cladding operation. In particular, it has been realized that by using a metallic wire and/or powder DED operation, a layer can be applied with pulses of directed energy at a particular spot. In this way the coating quickly cools again without affecting the surrounding material in a significant way. Thereby, a sensor member can be covered by a layer of a high performing material to form a raceway without affecting the sensing capabilities of the sensor members. Thereby, the sensor members can be applied without the need of expensive machining such as milling, while at the same time embedding the sensor members underneath the raceways, protecting them from wear from the rolling elements, thereby providing a reliable sensorized bearing ring in a cost-efficient manner. The raceway layer further provides the sensor members with protection from other type of wear affecting the sensing function, such as due to exposure to oils, water, debris and other contaminants. Further, as the coating material is rapidly heated and cooled, the microstructure of the raceway layer is refined, thereby improving the durability of the raceway, such as its thermal and shock resistance.

DED, such as laser cladding, as used herein means a surface welding operation which enables a metallurgical bonding of the steel wire material and/or steel metal powder to the metallic ring member, thereby providing a DED bonded surface on the metallic ring member. Other examples of DED, except laser cladding, are plasma transferred arc (PTA), electron beam melting (EBM), selected laser melting (SLM), thermal plasma spray and cold spray coating.

Optionally the sensor members are applied by printing the sensors onto the metallic ring member. Printing sensors and electronics is well known technologies ranging from thin film layer printing, think film printing, screen printing, non-contacting printing, roll printing to mention just a few examples. The technology to print the sensors is to deposit very small drops of ink or paste with a kind of printing cartridge, similar to paper printing.

Optionally, the method further comprises, prior to applying the raceway layer, providing a metallic or ceramic protecting member to cover the sensor member. Thereby, the sensor member is further protected from the DED-operation. Further optionally, the metallic or ceramic protecting member may be applied using sintering. By sintering is meant the process of compacting and forming a solid mass of material by heat or pressure without melting it to the point of liquefaction. As such, sintering requires less energy and temperature compared to melting the material as for the DED-operation, and forms a less solid material, thereby further isolating and reliably protecting the sensor members during the DED-operation.

Optionally, the metallic or ceramic protecting member is to be printed with the same technology and equipment for printing the sensor.

Optionally, the metallic wire and/or the metallic powder is any of a Ni-based alloy, a Co-based alloy or a Fe-based alloy, such as a stainless steel. Thereby, a corrosion, heat and wear resistant raceway layer can be provided by the DED operation, implying a high-performance raceway layer formed on the sensorized bearing ring.

By Ni/Co/Fe based alloys is meant alloys comprising 50 wt % or more of the mentioned base. By stainless steel is meant a Fe-based alloy comprising 12 wt % or more of Cr.

Optionally, applying the raceway layer may comprise applying more than one layer by use of DED, such as 2-20 layers. Providing more than one layer, such as 2-20 layers, has shown to result in a high-performance raceway layer with a satisfactory thickness for more demanding conditions.

Optionally, applying the raceway layer may be done by varying the application speed. Thereby, one or more layers with different radial thickness may be applied onto the metallic ring member. For example, the metallic ring member may be rotated with respect to a rotational axis of the metallic ring member while applying the coating, wherein the rotational speed is varied during application of the steel wire and/or steel metal powder on the metallic ring member. By varying the speed, less heat may be transferred to the metallic ring member during the DED operation. According to an example embodiment, the speed is varied by decreasing the speed at least one time during the application of the load carrying surface. Thereby a relatively high speed can be used when e.g. applying a first layer directly onto the metallic ring member, whereby a relatively low speed can be used when applying one or more additional layers on the first layer. Consequently, the first layer will be thinner than the one or more additional layers. This will result in that less heat will be transferred to the metallic ring member, thereby reducing the risk of deforming the metallic ring member during the DED operation, e.g. the laser cladding operation.

Still further, by varying the application speed, a surface with a varying radius may be provided with a coating with a substantially uniform thickness. For example, the metallic ring member may have for instance a concave, spherical or V-shaped raceway, i.e., in the case of radial bearings, presenting different radial distance from the metallic ring member's rotational axis, subsequently yielding different surface speed as the metallic ring member is rotated during application of the coating. Accordingly, the application speed may be varied such that a constant surface speed is achieved during the DED operation, thereby ensuring that a coating with a substantially uniform thickness is provided thereon.

Optionally, the speed when applying the coating by DED, i.e. the rotational speed of the metallic ring member, may be in the range of 0.5 to 1000 m (meter) per minute. According to an example embodiment, the DED speed is higher than 1 m per minute, such as higher than 20 m per minute, e.g. 80-120 m/minute, implying a reduced risk of deforming the sensor member. It has namely been found that a higher DED speed, such as rotational speed of the metallic ring member, may reduce the risk of deforming the sensor member.

Thereby, by e.g. using a higher laser cladding speed an improved sensorized bearing ring may be provided.

Optionally, when the DED operation is laser cladding, the laser power used when applying the coating may be 1-15 KW (kilowatts), such as 2-6 kW.

Optionally, the steps of applying a sensor member on the metallic ring member and applying a raceway layer onto the metallic ring member and the sensor member is performed by the same apparatus. Thereby, a more cost-efficient production set-up can be achieved.

By apparatus is meant a production cell having a robot, such as a robotic arm, equipped with different tools and a positioning table with a spindle chuck to place and rotate the ring member. The robotic arm may comprise tool for applying the sensor member, such as a printing head. The robotic arm may further have a sensor curing tool for curing the printed sensor, such as a laser or an UV-lamp. Further, the robotic arm may further be equipped with the tool for DED-operation to clad the raceway layers. Another benefit of this set-up is that the sensor curing tool and DED-operation tool could use the same laser source, further reducing the cost of the apparatus compared to having different stations or apparatus for the different steps.

According to a further aspect of the present invention, a sensorized bearing ring is presented. The sensorized bearing ring comprises
a metallic ring member,
a raceway layer, and
a sensor member positioned between the metallic ring member and the raceway layer. The raceway layer is formed by use of a metallic wire Directed Energy Deposition (DED) operation and/or a metallic powder DED operation.

It has been realized that by using a metallic wire and/or powder DED operation, a raceway layer can be applied with pulses of directed energy at a particular spot. In this way the raceway layer quickly cools again without affecting the surrounding material in a significant way. Thereby, a sensor member can be covered by a layer of a high performing material to form a raceway without affecting the sensing capabilities of the sensor members. Thereby, the sensor members can be applied without the need of expensive machining such as milling, while at the same time embedding the sensor members underneath the raceways, protecting them from wear from the rolling elements, thereby providing a reliable sensorized bearing ring in a cost-efficient manner. The raceway layer further provides the sensor members with protection from other type of wear affecting the sensing function, such as due to exposure to oils, water, debris and other contaminants. Further, as the coating material is rapidly heated and cooled, the microstructure of the raceway layer is refined, thereby improving the durability of the raceway, such as its thermal and shock resistance.

By “between” is meant that the sensor member is extending in relation to the metallic ring member and the raceway layer so that the metallic ring member and the raceway layer is substantially on opposing sides of the sensor member.

Optionally, the sensorized bearing ring further comprises, a metallic or ceramic protecting member covering the sensor member. Optionally, the metallic or ceramic protecting member may be applied using sintering. By sintering is meant the process of compacting and forming a solid mass of material by heat or pressure without melting it to the point of liquefaction. As such, sintering forms a less solid material, thereby further isolating and reliably protecting the sensor members from load and temperature emanating from the rolling elements during operation of the sensorized bearing comprising the sensorized bearing ring.

Optionally, the metallic wire and/or the metallic powder is any of a Ni-based alloy, a Co-based alloy or a Fe-based alloy, such as a stainless steel. Thereby, a corrosion, heat and wear resistant raceway layer can be provided by the DED operation, implying a high-performance raceway layer formed on the sensorized bearing ring.

Optionally, the raceway layer is from 0.5 mm to 10 mm thick in a radial direction. Below 0.5 mm thick and the reliability of the sensor may be affected, whereas more than 10 mm thick and the sensor readings as well at the cost benefit of using printed sensors and laser cladded raceways.

Optionally the thickness of the sensor member is from 10 to 200 microns. If the sensing member, including the optional protecting member, extends beyond 200 microns thick, the distance to the apparatus performing the DED-operation will be too big, negatively affecting the quality of the raceway layer.

According to a yet further aspect of the present invention, a sensorized bearing comprising a sensorized bearing ring according to any one of the embodiments herein and/or which has been manufactured by a method according to any of the embodiments herein is presented. Thereby, cost-efficient sensorized bearing with increased sensing reliability and service life robustness is achieved.

### BRIEF DESCRIPTION OF THE DRAWINGS

The present invention will hereinafter be further explained by means of non-limiting examples with reference to the appended schematic figures, where;

FIG. 1 is a view of a sensorized bearing ring according to an example embodiment of the present invention;

FIG. 2 is a cross sectional side view of the sensorized bearing ring in FIG. 1;

FIG. 3 is a cross-sectional view of the sensorized bearing ring in FIG. 1 along line A;

FIG. 4 is a cross-sectional view of the sensorized bearing ring in FIG. 1 along line B;

FIG. 5 is a flowchart of a method according to an example embodiment of the present invention;

FIG. 6 is a schematic view of a sensorized bearing ring before application of a raceway layer according to an example embodiment of the present invention;

FIG. 7 is a schematic view of a sensorized bearing ring before application of a raceway layer according to an example embodiment of the present invention; and

FIG. 8 is a schematic side view of a sensorized bearing according to the present invention.

It should be noted that the drawings have not necessarily been drawn to scale and that the dimensions of certain features may have been exaggerated for the sake of clarity. Like reference numerals in the drawings refer to similar parts unless expressed otherwise.

### DETAILED DESCRIPTION OF PREFERRED EMBODIMENTS

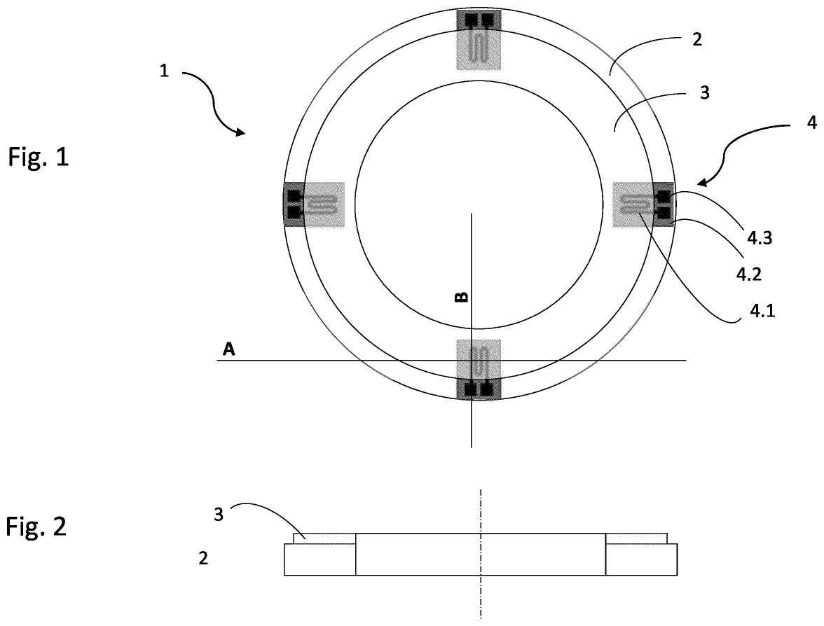

FIG. 1 depicts a view of a sensorized bearing ring 1 according to an example embodiment of the present invention.

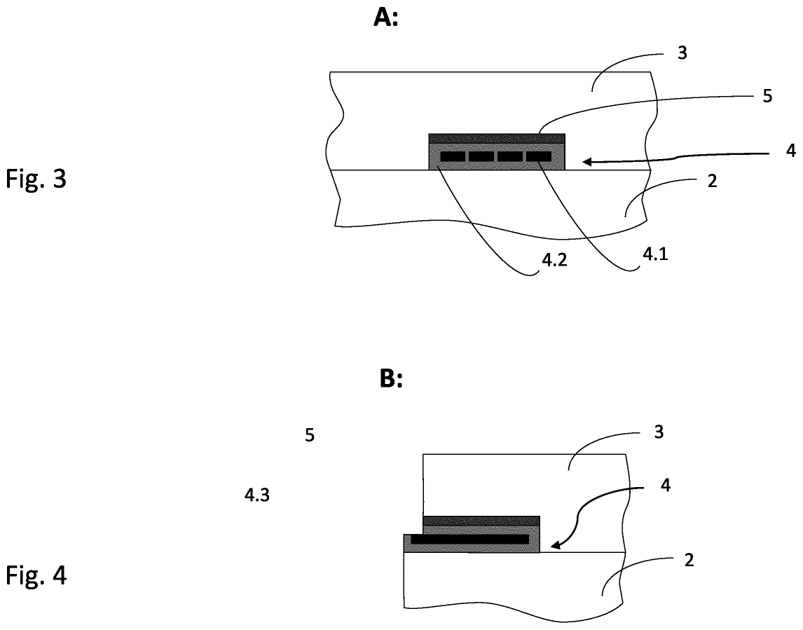

The sensorized bearing ring 1 has a metallic ring member 2, a raceway layer 3, and a sensor member 4 positioned between the metallic ring member 2 and the raceway layer 3. The raceway layer 3 is formed by use of a metallic wire Directed Energy Deposition (DED) operation and/or a metallic powder DED operation. The raceway layer 3 is shown here as a see-through layer. This to increase clarity of the parts inside the sensorized bearing 10 for to better see where the cross-sectional views have been made from in the FIG. 3-4. The sensor member 4 further comprises a sensing layer 4.1, such as a conductive layer, for sensing and generating signals. The sensing layer 4.1 may be a conductive layer that has been printed to the metallic ring member 2. The sensing member is further equipped with an insulation layer 4.4 for insulating the sensing layer 4.1 from the surrounding materials to achieve an accurate reading from the sensing layer 4.1. FIG. 1 further shows wiring contacts 4.3 for connecting wires from equipment to finally collect the collected data generated from the sensing layer 4.1.

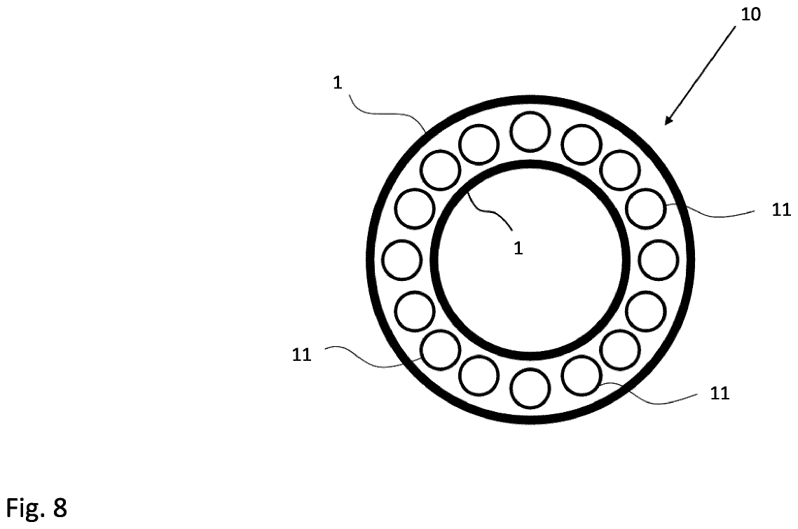

FIG. 2 depicts a cross sectional side view of the sensorized bearing ring 1 in FIG. 1 according to an example embodiment of the present invention. Here, the metallic ring member 2 and the raceway layer 3 applied by a DED-operation can be seen in greater detail. Here a thrust rolling bearing ring 2 is shown, i.e. a rolling bearing which loads are taken up substantially along an axial direction of a shaft (not shown). The rolling bearing may as well be a radial roller bearing 10 (see FIG. 8), i.e. a rolling bearing 10 where the loads are taken up substantially perpendicular to the axial extension of a supported shaft (not shown).

FIG. 3 depicts a cross-sectional view of the sensorized bearing ring 1 in FIG. 1 along line A, according to an example embodiment of the present invention. Here, the sensorized bearing ring 1 further comprises an optional metallic or ceramic protecting member 5 covering the sensor member 4. The protecting member 5 may be made by sintering. Sintering forms a less solid material, thereby further isolating and reliably protecting the sensor members 4 from load and temperature emanating from the rolling elements 11 during operation of the sensorized bearing 10 comprising the sensorized bearing ring 1.

FIG. 4 depicts a cross-sectional view of sensorized bearing ring 1 in FIG. 1 along line B, according to an example embodiment of the present invention. Here, the wiring contacts 4.3 of the sensing member is shown in greater detail, covered in the insulation layer 4.4 except at a point intended to connecting wire. This point is separated by the other metallic surfaces by the insulation layer 4.4, so that the sensing layer 4.1, such as a conductive sensing layer 4.1, is not interfered, by other metallic surfaces.

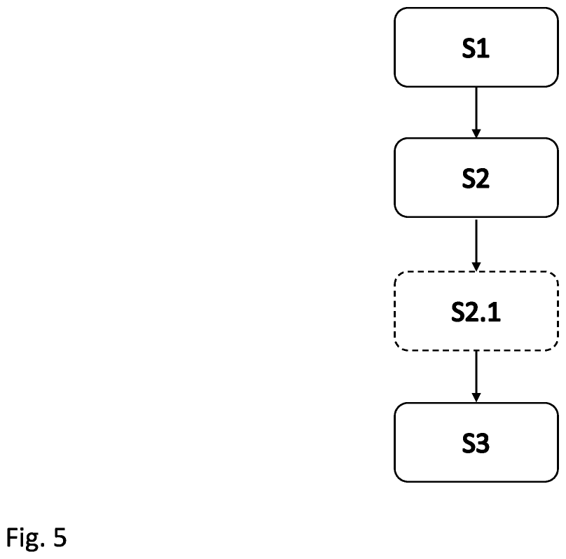

FIG. 5 depicts a flowchart of a method according to an example embodiment of the present invention. Here, a method for manufacturing a sensorized bearing ring 1 is provided. The method comprises the steps of:
providing a metallic ring member 2,
applying a sensor member 4 on the metallic ring member 2,
applying a raceway layer 3 onto the metallic ring member 2 and the sensor member 4 by use of a metallic wire Directed Energy Deposition (DED) operation and/or a metallic powder DED operation.

In an optional embodiment, the method comprising applying an optional metallic or ceramic protecting member 5. In a further optional embodiment, the metallic or ceramic protecting member 5 is applied by using sintering. By sintering is meant the process of compacting and forming a solid mass of material by heat or pressure without melting it to the point of liquefaction. As such, sintering forms a less solid material, thereby further isolating and reliably protecting the sensor members 4 from load and temperature emanating from the rolling elements 11 during operation of the sensorized bearing 10 comprising the sensorized bearing ring 1.

In an optional embodiment, the sintering layer is formed by the same tool that applies the sensor layer.

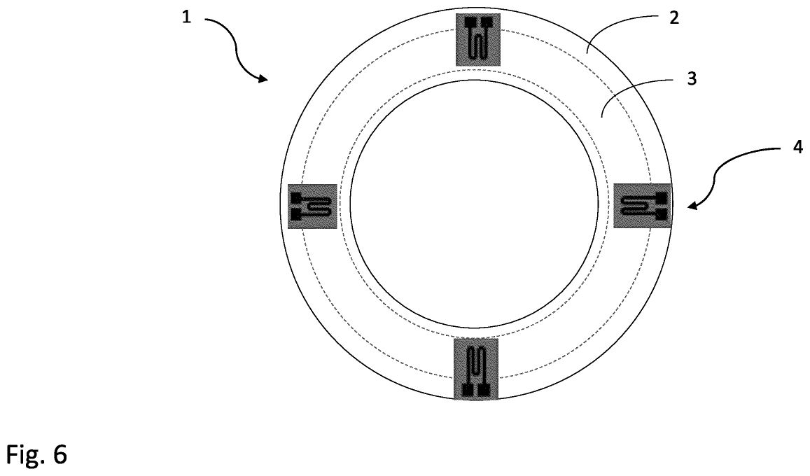

FIG. 6 depicts a schematic view of a sensorized bearing ring 1 before application of a raceway layer 3 according to an example embodiment of the present invention.

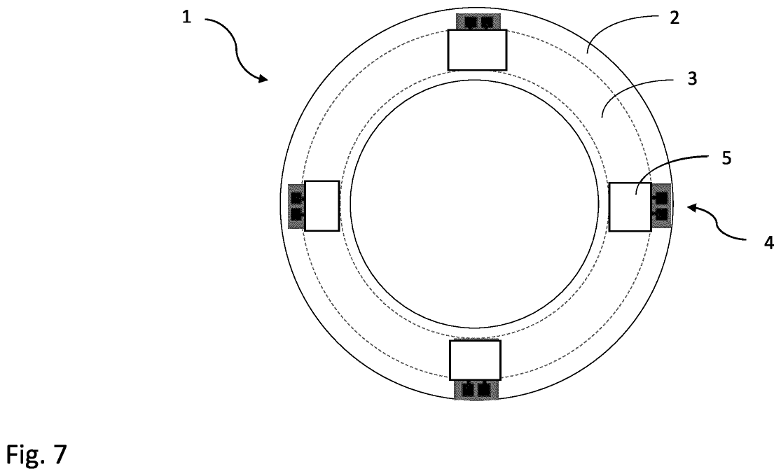

FIG. 7 depicts a schematic view of a sensorized bearing ring 1 before application of a raceway layer 3 according to an example embodiment of the present invention.

FIG. 8 depicts a schematic side view of a sensorized bearing according to the present invention. Here, the rolling bearing is shown as a radial rolling bearing 10 comprising rolling elements 11 in between two bearing rings, of which at least one is a sensorized bearing ring 1. Here, the outer bearing ring is a sensorized bearing ring 1, but it may be so that the inner ring or even both rings are sensorized.

It is to be understood that the present invention is not limited to the embodiments described above and illustrated in the drawings; rather, the skilled person will recognize that many changes and modifications may be made within the scope of the appended claims.

1. A method for manufacturing a sensorized bearing ring, the method comprising the steps of:
providing a metallic ring member,
applying a sensor member on the metallic ring member, and
applying a raceway layer onto the metallic ring member and the sensor member by use of a metallic wire Directed Energy Deposition operation and/or a metallic powder DED operation.

2. The method according to claim 1, further comprising a step of applying a metallic or ceramic protecting member to cover the sensor member prior to applying the raceway layer.

3. The method according to claim 2, wherein the step of applying a metallic or ceramic protecting member is made by sintering.

4. The method according to claim 1, wherein the step of applying the raceway layer includes applying more than one layer by use of DED.

5. The method according to claim 1, wherein an application speed is varied during application of the metallic wire material and/or metallic powder on the metallic ring member.

6. The method according to claim 1, wherein the steps of applying the sensor member on the metallic ring member and applying a raceway layer on the metallic ring member and the sensor member are performed by the same apparatus.

7. A sensorized bearing ring, comprising:
a metallic ring member,
a raceway layer formed on the metallic ring member by use of a metallic wire Directed Energy Deposition operation and/or a metallic powder DED operation, and
a sensor member positioned between the metallic ring member and the raceway layer.

8. The sensorized bearing ring according to claim 7, further comprising a metallic or ceramic protecting member between the sensor member and the raceway layer.

9. The sensorized bearing ring according to claim 7, wherein the raceway layer is formed of any of a Co-based alloy, a Ni-based alloy, or a Fe-based alloy.

10. A bearing comprising a sensorized bearing ring according to claim 7.

11. A bearing comprising a sensorized bearing ring manufactured by the method according to claim 1.

12. The method according to claim 4, wherein the step of applying the raceway layer includes applying 2-20 layers by use of DED.

13. The sensorized bearing ring according to claim 9, wherein the Fe-based alloy is a stainless steel.
